(19) United States
(12) Patent Application Publication
(10) Pub. No.: US 2009/0324819 A1
(43) Pub. Date: Dec. 31, 2009

(54) METHODS FOR INCREASING POLYCRYSTALLINE SILICON REACTOR PRODUCTIVITY BY RECYCLE OF SILICON FINES

(75) Inventors: Milind S. Kulkarni, St. Louis, MO (US); Steven L. Kimbel, St. Charles, MO (US); Jameel Ibrahim, Humble, TX (US); Vithal Revankar, Seabrook, TX (US)

Correspondence Address: Richard A. Schuth (MEMC);Armstrong Teasdale LLP, One Metropolitan Square, Suite 2600, St. Louis, MO, 63102-2740, US

(73) Assignee: MEMC ELECTRONIC MATERIALS, INC., St. Peters, MO (US)

(21) Appl. No.: 12/492,706

(22) Filed: Jun. 26, 2009

Related U.S. Application Data
(60) Provisional application No. 61/076,371, filed on Jun. 27, 2008.

(51) Int. Cl. B05D 3/02

(52) U.S. Cl. 427/215

(57) ABSTRACT

Processes for producing polycrystalline silicon include contacting silicon particles with a thermally decomposable silicon compound in a reaction chamber. A portion of the silicon decomposable compound decomposes to produce silicon dust which is discharged from and reintroduced into the reaction chamber. The discharged silicon dust agglomerates with the silicon particles.

### CROSS-REFERENCE TO RELATED APPLICATION

This application claims the benefit of U.S. Provisional Application No. 61/076,371, filed Jun. 27, 2008, the contents of which are incorporated herein by reference for all relevant and consistent purposes.

### BACKGROUND OF THE INVENTION

This invention relates to fluidized bed reactor systems for producing polycrystalline silicon and, more particularly, to methods for increasing reactor productivity during production of polycrystalline silicon from a thermally decomposable silicon compound such as, for example, silane.

Polycrystalline silicon is a vital raw material used to produce many commercial products including, for example, integrated circuits and photovoltaic (i.e., solar) cells. Polycrystalline silicon is typically produced by a chemical vapor deposition mechanism in which silicon is deposited from a thermally decomposable silicon compound onto silicon particles in a fluidized bed reactor. The seed particles continuously grow in size until they exit the reactor as polycrystalline silicon particles product (i.e., “granular” polycrystalline silicon). Suitable decomposable silicon compounds include, for example, silane and halosilanes (e.g., trichlorosilane).

Polycrystalline “seed” particles may be added to the reaction chamber to initiate deposition of silicon. The particle size of the crystal seed particles may be from about 50 μm to about 800 μm and more typically may be from about 250 μm to about 600 μm. Two types of silicon seed particles are commonly used. One source of silicon seed particles are product particles collected from the reactor that are ground to a typical particle size from about 250 μm to about 350 μm. Alternatively or in addition, small polycrystalline particles gathered with and separated from the granular polycrystalline product having a particle size of from about 500 μm to about 600 μm may be used as seed particles.

A variety of reactions may take place in the reaction chamber. The reaction mechanisms which are known to occur in a silane fluidized bed reactor system are generally illustrated in FIG. 1. These mechanisms in no way limit embodiments of the present invention as they do not constitute the entire set of reactions which may occur in the reactor system.

With reference to FIG. 1, in a silane system, silane heterogeneously deposits onto the growing crystal particle (1). Silane may also decompose to produce silicon vapor (3) which can homogenously nucleate to form undesirable silicon dust (synonymously referred to as silicon “fines” or “powder”) (4) and which can deposit on the growing silicon particles (6). The silicon fines can grow in size by deposition of silicon from silane (2) or from silicon vapor (5). The fines can agglomerate to form larger fines (7). Silicon fines can also combine with larger growing silicon particles, i.e., the silicon fines may be scavenged by the larger growing silicon particles (8).

Typically, the particle size of the silicon dust is less than about 50 μm and in some embodiments may be less than about 5 μm. Granular polycrystalline product typically has a particle size of from about 600 μm to about 2000 μm and more typically from about 800 μm to about 1200 μm or even from about 900 μm to about 1000 μm.

As silicon deposits from silane onto a growing silicon particle, hydrogen is released from the silane molecule. The silicon dust is carried out of the reactor with the hydrogen gas and unreacted silane as well as carrier gases typically added to the reactor with the silane (collectively “spent gas”). The silicon dust is separated from the spent gas that exits the reactor by, for example, bag-filtration, cyclone separation or liquid scrubbers.

Recovered silicon dust may be used industrially but it has less value than granular polycrystalline silicon. For instance, silicon dust may be used to produce monocrystalline silicon by the Czochralski method, a method that involves drawing single crystal silicon from melted polycrystalline silicon by pulling a seed crystal brought into contact with the molten polycrystalline silicon. When silicon dust is used in the Czochralski method, the silicon dust is difficult to melt and it is more difficult to pull the crystal from the melt. As a result, silicon dust is sold at a large discount as compared to granular polycrystalline silicon. Thus, a need exists for reactor systems and methods for reducing the amount of silicon dust produced in granular polycrystalline reactor systems.

### SUMMARY OF THE INVENTION

One aspect of the present invention is directed to a process for producing polycrystalline silicon wherein silicon particles are contacted with a thermally decomposable silicon compound in a reaction chamber to cause silicon to deposit onto the silicon particles, the silicon particles increasing in size as silicon is deposited. A portion of the silicon vapor formed by the thermal decomposition of the silicon compound is converted to silicon dust (also referred to as fines) and is discharged from the reaction chamber. At least a portion of the discharged silicon dust is recycled to the reaction chamber wherein the recycled silicon dust is at least partially scavenged by silicon particles, such that the dust scavenging rate increases with the recycle.

Another aspect of the present invention is directed to a process for producing polycrystalline silicon wherein silicon particles are contacted with a thermally decomposable silicon compound in a reaction chamber to cause silicon to deposit onto the silicon particles, the silicon particles increasing in size as silicon is deposited. A portion of the silicon vapor formed by the thermal decomposition of the silicon compound is converted to silicon dust and is discharged from the reaction chamber. At least a portion or nearly all of the discharged silicon dust is recycled to the reaction chamber wherein the recycled silicon dust is at least partially or even completely scavenged by silicon particles at a rate substantially equal to the rate at which the silicon dust is formed, thereby lowering the net dust formation to a rate at or about zero.

Various refinements exist of the features noted in relation to the above-mentioned aspects of the present invention. Further features may also be incorporated in the above-mentioned aspects of the present invention as well. These refinements and additional features may exist individually or in any combination. For instance, various features discussed below in relation to any of the illustrated embodiments of the present invention may be incorporated into any of the above-described aspects of the present invention, alone or in any combination.

### BRIEF DESCRIPTION OF THE DRAWINGS

FIG. 1 is a graphical depiction of reaction mechanisms that take place in a granular polycrystalline silicon reactor system;

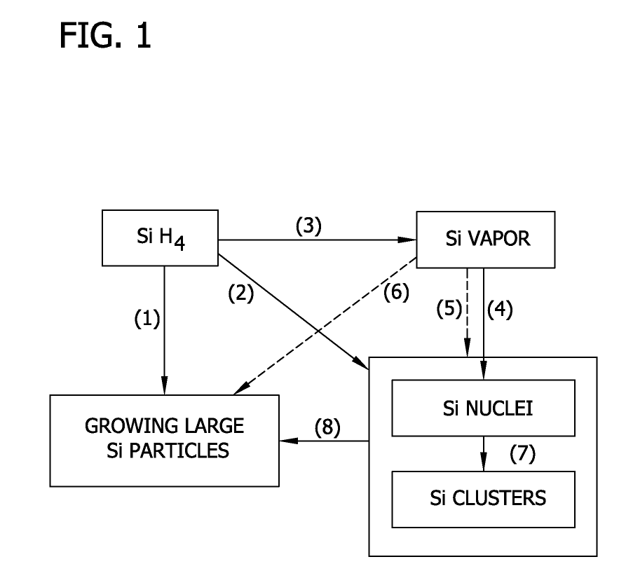

FIG. 2 is a schematic flow diagram of an embodiment of a granular polycrystalline silicon reactor system; and

FIG. 3 is graph showing the calculated fines concentration for a fluidized bed reactor as a function of time, with time zero being the time fines are initially recycled to the reactor.

### DETAILED DESCRIPTION

The process of the present invention includes introducing a feed gas including a gaseous silicon compound capable of being thermally decomposed and silicon particles into a reactor. The silicon particles are fluidized by the incoming feed gas. The feed gas is heated in the reaction chamber to cause at least a portion of the silicon in the silicon compound to deposit, by chemical vapor deposition, onto the silicon particles thereby growing the silicon particles into larger particles typically referred to as granular polysilicon. Another portion of the thermally decomposable silicon compound decomposes to form, among other things, silicon vapor.

The silicon vapor may deposit, at least in part, on the silicon particles thereby contributing to the growth of the particles. In addition, however, the silicon vapor forms small polysilicon crystals, typically referred to as polysilicon fines also referred to herein as polysilicon dust by homogeneous nucleation. At least a portion of the polysilicon dust becomes entrained in the fluid passing through the reactor chamber and discharged with the spent gas. The spent gas may be processed to separate at least a portion of the silicon dust from the gas stream and the silicon dust may be returned to the reaction chamber. Once reintroduced into the reaction chamber, the silicon dust increases the dust scavenging rate by adhering to silicon particles thereby forming agglomerates of increased size compared to the particles prior to the silicon dust adhering to their surface. Advantageously, the process of embodiments of the present invention thereby converts silicon dust, typically sold at lower prices than the granular particles, to be sold as part of the agglomerated particle thereby improving the profitability of the process.

It should be noted that any reactor capable of carrying out the above described reactions may be used without departing from the scope of the present invention. Such reactors are generally described as fluidized bed reactors. Furthermore, the process of embodiments of the present invention may carry out the reaction in a single fluidized bed reactor or may incorporate one or more fluidized bed reactors configured in series or in parallel. The fluidized bed reactors may be operated as described, for example, in United States Patent Pub. No. 2006/0105105, the entire contents of which are incorporated herein by reference for all relevant and consistent purposes.

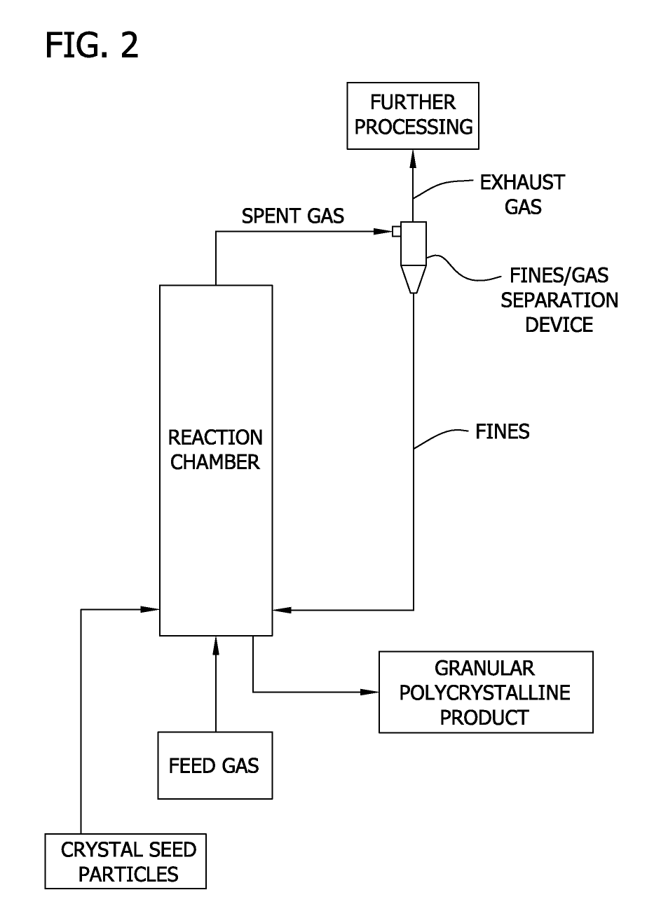

A schematic diagram illustrating an embodiment of the process of embodiments of the present invention is depicted in FIG. 2.

### Feed Gas

Thermally decomposable silicon compounds include compounds generally capable of being thermally decomposed in a gas phase to produce silicon. Additional products may be produced from the decomposition process, without departing from the scope of the present invention, as long as it provides a source of silicon to grow the polysilicon particles to form polysilicon granules. Thermally decomposable silicon compound gases include all gases containing silicon that can be heterogeneously deposited by chemical vapor deposition, such as silicon tetrahydride (commonly referred to as silane), trichlorosilane and other silicon halides, wherein one or more of the hydrogen atoms of silane is substituted with a halogen such as chlorine, bromine, fluorine and iodine.

In one embodiment, the thermally decomposable silicon compound is silane. The chemical vapor deposition (CVD) of silane is slightly exothermic, typically goes substantially to completion, is nearly irreversible, and may be initiated at a lower temperature of about 600° C. compared to silicon halide gases such as trichlorosilane, which typically requires a temperature of at least about 1100° C. In addition, silane and its decomposition products, i.e., silicon vapor and hydrogen, are non-corrosive and non-polluting. In comparison, the decomposition of trichlorosilane is a reversible and incomplete reaction which results in the production of byproducts which are corrosive. In general, therefore, silane is a preferred gas for use in embodiments of the present invention, although other thermally decomposable gases containing silicon may be utilized without departing from the scope of the present invention.

The thermally decomposable compound may be introduced into the reactor without dilution or the gas may be diluted with a carrier gas such as hydrogen, argon, helium or combinations thereof. During decomposition, by-product hydrogen is produced that may be used as needed as a carrier gas for additional quantities of thermally decomposable feed gas in the operation of the reactor system.

### Reaction Chamber

The reaction chamber is typically a fluidized bed in which silicon particles are suspended by an upward flow of the fluidizing gas in the reactor. Fluidized bed reactors provide high mass transfer and heat transfer rates between growing silicon particles and the gas phase which enhances the deposition rate of silicon onto the particles. The fluidized bed reactor is generally a cylindrical vertical vessel; however, any configuration that is acceptable to fluidized bed operations may be utilized. The particular dimensions of the reactor will be primarily depend upon system design factors that may vary from system to system such as the desired system output, heat transfer efficiencies and system fluid dynamics, without departing from the scope of the present invention. Typically, extraneous heat is used to cause the temperature of the thermally decomposable gas to increase to the point at which the gas decomposes. Methods for heating include, for example, capacitive heating, induction coils and electrical resistance elements.

### Reaction Conditions

During operation of the reaction system, the fluidizing gas velocity through the reaction zone is maintained above the minimum fluidization velocity of the silicon particles. The gas velocity through the reactor is generally maintained at a velocity of from about one to about eight times the minimum fluidization velocity necessary to fluidize the particles within the fluidized bed. In some embodiments, the gas velocity is from about two to about five times and, in at least one embodiment, is about four times the minimum fluidization velocity necessary to fluidize the particles within the fluidized bed. The minimum fluidization velocity varies depending on the properties of the gas and particles involved. The minimum fluidization velocity may be determined by conventional means (see p. 17-4 of Perry's Chemical Engineers' Handbook, 7th. Ed., incorporated herein by reference).

The minimum fluidization velocity is preferably calculated for conditions as they exist near the gas distributor. Using these conditions, which include temperatures that are normally cooler than the rest of the reactor, it is possible to ensure the minimum fluidization velocity calculated be sufficient to fluidize the entire bed. At elevated temperatures above the distributor, the viscosity and velocity variables utilized to calculate the minimum fluidization velocity are heat sensitive and may result in a minimum fluidization velocity that is not sufficient to fluidize the bed at the cooler temperatures of the lower portions of the bed. Therefore, by calculating a minimum fluidization velocity based on the cooler conditions, it is possible to ensure the calculation of the lowest fluidization gas velocity that will fluidize the entire bed. Although the present invention is not limited to specific minimum fluidization velocities, minimum fluidization velocities useful in the present invention range from about 0.7 cm/sec to about 350 cm/sec or even from about 6 cm/sec to about 150 cm/sec.

Gas velocities higher than the minimum fluidization flow rate are often desired to achieve higher productivities. As the gas velocity increases beyond the minimum fluidization velocity, the excess gas forms bubbles, increasing the bed voidage. The bed can be viewed to consist of bubbles and “emulsion” containing gas in contact with silicon particles. The quality of the emulsion is quite similar to the quality of the bed at the minimum fluidization condition. The local voidage in the emulsion is close to the minimum fluidization bed voidage. Hence, bubbles are generated by the gas introduced in excess of what is required to achieve the minimum fluidization. As the ratio of actual gas velocity to the minimum fluidization velocity increases, the bubble formation intensifies. At a very high ratio, large slugs of gas are formed in the bed. As the bed voidage increases with the total gas flow rate, the contact between solids and gases becomes less effective. For a given volume of the bed, the surface area of solids in contact with reacting gases decreases with increasing bed voidage. Thus, for the given bed length, the conversion of thermally decomposable gas decreases. Conversion may also decrease for reduced gas residence times. In addition, different undesired reactions can take place at higher rates producing more fines.

The temperature in the reactor is maintained within the decomposition temperature range of the thermally decomposable compound and the melting point temperature of silicon. The temperature of the reactor may be maintained from about 200° C. to about 1400° C., typically from about 600° C. to about 700° C. or even from about 625° C. to about 655° C. The heat that is used to maintain the reaction zone at such temperatures may be provided by conventional heating systems such as electrical resistance heaters disposed on the exterior of the reactor vessel wall. The pressure in the reactor is typically about 1.73 atmosphere at the top of the bed.

### Fines Separation and Recycle

It has been discovered that silicon fines exiting the reactor in the spent gas may be recovered and recycled to the reactor without detrimentally affecting reactor system dynamics. It was found that recycled fines may wholly agglomerate with the larger silicon particles. The fines may be partially or totally recycled to the reactor system. Under total fines recycle operation, the system comes to a steady state condition in which the overall fines production rate in the reactor equals the overall rate at which the fines are scavenged by the silicon particles and the effective net fines production is reduced to about zero.

As shown in FIG. 2, fines exiting the reactor with the spent gas are separated and recycled back to the reactor. The silicon fines are separated from the spent gas in a fines/gas separation device such as, for example, bag filtration, cyclone separation or liquid scrubbers. The fines/gas separation device is effective in removing from the spent gas fines formed by homogeneous nucleation in the reactor. Preferably, the fines/gas separation device removes at least about 90% of the fines in the spent gas, more preferably, at least about 95% of the fines and, most preferably, at least about 99% of the fines.

Fines may be transported from the fines/gas separation device to the reactor by conveying equipment (e.g., pneumatic transport, screw conveyor, belt conveyor or roller belt) or any other suitable equipment for transport. The fines may be introduced into the reactor at any location, but preferably are introduced toward the bottom portion of the reactor. The fines may also be introduced into the reactor by an airlock or other suitable device. For further process control, the fines exiting the fines/gas separation device may be collected in a separate container or a tank and the fines may be fed to the reactor from the tank. The fines may also be recycled by combining the fines with the feed gas and/or a carrier gas.

The exhaust exiting the fines/gas separation device typically contains hydrogen and carrier gases and may be subjected to further processing. For example, a portion of the exhaust gas may be compressed and utilized in other processes within the system. In addition or alternatively, a portion of the exhaust gas may be recycled to the reactor as a carrier gas, in which case, a portion or all of the recycled fines may be recycled by combining the fines with the exhaust gas being recycled to the reactor.

The rate at which fines are scavenged by the particles increases with increasing fines concentration in the reactor. In conventional fluidized bed reactor systems, the overall fines production rate is generally greater than the overall fines scavenging rate, resulting in the discharge of fines with the exit gases. Recycling a portion or all of these fines results in an increase in the fines concentration and a corresponding increase in the scavenging rate.

In some embodiments, only a portion of the fines exiting the reactor are recycled. The net production rate of fines is finite in the reactor but is lower than that in an otherwise identical system operating without fines recycle. The fines selectivity of the system (i.e., the fraction of converted thermally decomposable gas that ultimately leaves the system as fines) can be controlled by varying the portion of fines being recycled.

In some embodiments, substantially all of the fines exiting the reactor are recycled back into the reactor. In other embodiments, a portion or all of the fines are fed to an additional fluidized bed reactor rather than the reactor in which they were generated.

### EXAMPLES

### Example 1

### Computer Simulation of Steady-State Conditions in a Fluidized Bed System with Fines Recycle

This example demonstrates the evolution of total fines density in a fluidized bed reactor with fines recycle (FRFBR). Time zero refers to the condition in the FRFBR at the onset of recycle. This also represents the time-averaged steady state in the standard fluidized bed reactor without fines recycle.

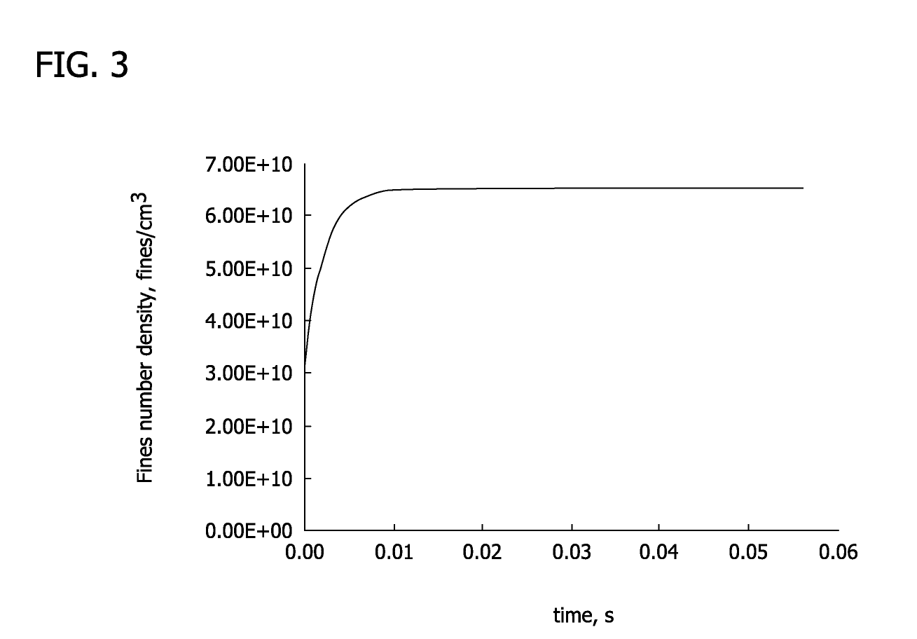

In a computer simulated example, wherein 100% of the fines are recycled back to a fluidized bed reactor producing granular polysilicon, the concentration of fines in the reactor as a function of time was calculated. As shown in FIG. 3, the average fines concentration in the reactor at time zero represents the steady state fines concentration prior to recycling the fines. At time zero, the recycle was initiated and the average concentration of fines in the reactor was calculated as a function of time, using the computer simulation. The concentration quickly increased, but leveled off at a new steady state. The results, shown in FIG. 3, confirm that the fines may be completely recycled without resulting in a continuous build up of fines in the reactor system. Stated differently, using 100% recycle, the concentration of fines quickly reached a new steady state at which point, the fines scavenging rate equaled the rate at which fines were generated. While the actual fines density at a given time-averaged steady state may vary depending on the approximations in the computer simulation model, the qualitative behavior of the system nevertheless remains the same.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above methods without departing from the scope of the invention, it is intended that all matter contained in the above description and shown in the accompanying figures shall be interpreted as illustrative and not in a limiting sense.

What is claimed is:

1. A process for producing polycrystalline silicon comprising:
contacting silicon particles with a thermally decomposable silicon compound in a reaction chamber to cause silicon to deposit onto the silicon particles, the silicon particles increasing in size as silicon is deposited, wherein a portion of the silicon decomposable compound decomposes to produce silicon dust;
discharging silicon dust from the reaction chamber; and
introducing at least a portion of the discharged silicon dust to the reaction chamber to cause the discharged silicon dust to agglomerate with the silicon particles.

2. A process as set forth in claim 1 wherein all of the discharged silicon dust is introduced into the reaction chamber.

3. A process as set forth in claim 1 wherein the silicon dust is discharged from the reaction chamber with the spent gas.

4. A process as set forth in claim 3 wherein the discharged silicon dust is separated from the spent gas.

5. A process as set forth in claim 4 wherein a feed gas comprising the decomposable silicon compound is continuously introduced into the reaction chamber and wherein the discharged silicon dust is introduced into the feed gas prior to introduction into the reaction chamber.

6. A process as set forth in claim 4 wherein the discharged silicon dust is separated from the spent gas by filtration.

7. A process as set forth in claim 3 wherein a portion of the discharged silicon dust is introduced to the reaction chamber with a portion of the spent gas.

8. A process as set forth in claim 1 wherein a portion of the silicon particles is removed from the reaction chamber as polycrystalline particles product.

9. A process as set forth in claim 1 wherein the particles are between about 800 μm and about 1200 μm in nominal diameter.

10. A process as set forth in claim 1 wherein the silicon dust is less than about 5 μm in nominal diameter.

11. A process as set forth in claim 1 wherein the temperature of the reaction chamber is between about 200° C. and 1400° C.

12. A process as set forth in claim 1 wherein the temperature of the reaction chamber is between about 600° C. and 700° C.

13. A process for producing polycrystalline silicon comprising:
depositing silicon from a thermally decomposable silicon compound onto silicon particles to form polycrystalline particles product;
decomposing the thermally decomposable silicon compound to form silicon dust; and
scavenging the silicon dust with silicon particles at a rate substantially equal to the rate at which the silicon dust is formed.

14. A process as set forth in claim 13 wherein silicon is deposited onto the silicon particles in a reaction chamber.

15. A process as set forth in claim 14 wherein the silicon dust is discharged from the reaction chamber.

16. A process as set forth in claim 15 wherein the discharged silicon dust is recycled back to the reaction chamber.

17. A process as set forth in claim 15 wherein the silicon dust is discharged from the reaction chamber with the spent gas.

18. A process as set forth in claim 17 wherein the discharged silicon dust is separated from the spent gas.

19. A process as set forth in claim 18 wherein a feed gas comprising the decomposable silicon compound is continuously introduced into the reaction chamber and wherein the discharged silicon dust is introduced into the feed gas prior to introduction into the reaction chamber.

20. A process as set forth in claim 18 wherein the discharged silicon dust is separated from the spent gas by filtration.

21. A process as set forth in claim 17 wherein a portion the discharged silicon dust is introduced to the reaction chamber with a portion of the spent gas.

22. A process as set forth in claim 13 wherein a portion of the silicon particles is removed from the reaction chamber as polycrystalline particles product.

23. A process as set forth in claim 13 wherein the particles product is between about 800 μm and about 1200 μm in nominal diameter.

24. A process as set forth in claim 13 wherein the silicon dust is less than about 5 μm in nominal diameter.

25. A process as set forth in claim 13 wherein the temperature of the reaction chamber is between about 200° C. and 1400° C.

26. A process as set forth in claim 13 wherein the temperature of the reaction chamber is between about 600° C. and 700° C.
